(19) United States
(12) Patent Application Publication
(10) Pub. No.: US 2008/0101996 A1
(43) Pub. Date: May 1, 2008

(54) Multi-channel design for a liquid-handling pipette

(75) Inventor: David Daf, Taipei (TW)

Correspondence Address: Ladas & Parry LLP, 26 West 61st Street, New York, NY, 10023, US

(73) Assignee: TAIGEN BIOSCIENCE CORPORATION

(21) Appl. No.: 11/590,289

(22) Filed: Oct. 31, 2006

(51) Int. Cl. B01L 3/02

(52) U.S. Cl. 422/100

(57) ABSTRACT

A multi-channel liquid-handling pipette is provided having a top portion and a bottom portion. The top portion is disposed with a plurality of inlets and the bottom portion is disposed with a plurality of pipetting heads for mounting tips. Each of the inlets is connected to a syringe or an apparatus with the functions of both quantitatively aspirating and dispensing liquid and being in communication with the corresponding pipetting head. Each of the tips corresponds to a respective well of a multi-well plate. The multi-well plate is arranged as a 6×4, 12×8 or 24×16 array having a channel spacing of 18 mm, 9 mm and 4.5 mm between two adjacent wells, respectively, while the pipetting heads are arranged as a 6×4 array having an 18 mm channel spacing between two adjacent pipetting heads.

### BACKGROUND OF THE INVENTION

1. Field of the Invention

The present invention relates to a liquid-handling pipette having a multi-channel design.

2. Description of the Related Art

Modern laboratories, for example, clinical and biological laboratories, often require the simultaneous processing of large amounts of assays. Nowadays multi-well plates are widely used to effectively handle such process. Conventional multi-well plates may have a 24-well, a 96-well or a 384-well configuration and are arranged in a rectangular configuration with a fixed centre-to-centre spacing (channel spacing). For example, a 24-well multi-well plate is arranged as a 6×4 array with a channel spacing of 18 mm, a 96-well multi-well plate is arranged as a 12×8 array with a channel spacing of 9 mm, while a 384-well multi-well plate is arranged as a 24×16 array with a channel spacing of 4.5 mm.

Liquid handling plays an important part during the majority of laboratory processes. Pipettes, which are one type of major tool for liquid handing, can quantitatively aspirate and dispense liquid. There are different pipette designs to suit different needs. Generally, multi-well plates are used in conjunction with pipettes having multiple channels so as to speed up the process. At the moment there are two kinds of pipettes on the market. One has a fixed channel spacing while the other has an adjustable channel spacing which, in turn, has a more complicated mechanism. Conventional pipettes having a fixed channel spacing are 8-channel with a channel spacing of 9 mm (referring to FIGS. 1 and 2), 12-channel with a channel spacing of 9 mm, 96-channel with a channel spacing of 9 mm (referring to FIG. 3), or 384-channel with a channel spacing of 4.5 mm. Pipettes having an adjustable channel spacing are 8-channel and 12-channel, whose adjustable spacing is varied but often ranges between 9 and 20 mm.

Pipettes having a fixed channel spacing are normally used in conjunction with multi-well plates having the same or smaller spacing. For example, 12-channel pipettes having a fixed 9 mm channel spacing are suitable for 96-well plates and 384-well plates but are unsuitable for multi-well plates having a larger channel spacing, such as 24-well plates. Pipettes having an adjustable channel spacing ranging between 9 and 20 mm can be used in 24-well, 96-well, 384-well and the so-called “tube-to-plate transfers” of liquid handling, i.e., if a plurality of test tubes having a diameter larger than 9 mm is properly arranged, a pipette having an adjustable channel spacing can be applied to aspirate liquid assays in the test tubes and subsequently dispense the liquid assays into, for example, a 96-well plate. Such application can effectively speed up the processing of liquid assays without the need to manually transfer the liquid assays from each individual test tube to the corresponding well of the 96-well plate.

In general, liquid handlers having more pipetting heads can process more assays simultaneously and therefore are more efficient. As described in the previous paragraph, conventional pipettes having a fixed channel spacing are 8-channel, 12-channel, 96-channel, or 384-channel. FIGS. 1 and 2 show schematic views of a conventional liquid handler having an 8-channel liquid-handling pipette. It can be seen that to fill-up a conventional 12×8 array multi-well plate, the liquid hander needs to perform “aspirate and dispense” actions 12 times, while a liquid handler having a 12-channel liquid-handling pipette needs to perform “aspirate and dispense” actions 8 times, which are both rather time consuming. As explained in the previous paragraph, the 8-channel and 12-channel arrangements are unsuitable for multi-well plates having a larger channel spacing, such as 24-well plates. Again, as stated in the previous paragraph, pipettes having an adjustable channel spacing have a more complicated mechanism, and thus are expensive.

To overcome the drawbacks mentioned among the existing liquid handlers, a multi-channel liquid-handling pipette is provided which is suitable for multi-well plates of different configurations, can speed up processing of liquid assays compared to the conventional 8-channel and 12-channel pipettes and perform “tube-to-plate transfers,” and offers a cheap and easy way to be manufactured.

### SUMMARY OF THE INVENTION

It is an object of the present invention to provide a multi-channel liquid-handling pipette which is suitable for multi-well plates of different configurations, can speed up processing of liquid assays compared to the conventional 8-channel and 12-channel pipettes and perform “tube-to-plate transfers,” and offers a cheap and easy way to be manufactured.

According to the present invention, the multi-channel liquid-handling pipette has a top portion and a bottom portion. The top portion is disposed with a plurality of inlets and the bottom portion is disposed with a plurality of pipetting heads for mounting tips. Each of the inlets is connected to a syringe or an apparatus with functions of both quantitatively aspirating and dispensing liquid and being in communication with the corresponding pipetting head. Each of the tips corresponds to a respective well of a multi-well plate. The multi-well plate is arranged as a 6×4, 12×8 or 24×16 array having a channel spacing of 18 mm, 9 mm and 4.5, mm between two adjacent wells, respectively, while the pipetting heads are arranged as a 6×4 array having an 18 mm channel spacing between two adjacent pipetting heads.

Other objects, advantages and novel features of the present invention will be drawn from the following detailed description of preferred embodiments of the present invention with the accompanying drawings, in which:

### DESCRIPTIONS OF THE DRAWINGS

FIG. 1 illustrates a schematic view of a conventional liquid handler at a robotic workstation;

FIG. 2 illustrates a schematic view of a conventional multi-channel liquid-handling pipette having an 8-pipetting arrangement;

FIG. 3 illustrates a schematic view of an alternative conventional multi-channel liquid-handling pipette having a 12×8 array pipetting arrangement;

FIG. 4 illustrates a schematic view of a 6×4 multi-channel liquid-handling pipette performing “tube-to-plate transfers” according to the present invention;

FIG. 5 illustrates a locally enlarged schematic view of the tips of the multi-channel liquid-handling pipette of FIG. 4 approaching the respective wells of a 12×8 multi-well plate;

FIG. 6 illustrates a schematic view of the tips of the 6×4 multi-channel liquid-handling pipette having a channel spacing of 18 mm approaching the respective wells of a 6×4 multi-well plate having a channel spacing of 18 mm;

FIG. 7 illustrates a schematic view of the tips of the 6×4 multi-channel liquid-handling pipette of FIG. 4 approaching the respective wells of a 12×8 multi-well plate having a channel spacing of 9 mm; and

FIG. 8 illustrates a schematic view of the tips of the 6×4 multi-channel liquid-handling pipette approaching the respective wells of a 24×16 multi-well plate having a channel spacing of 4.5 mm.

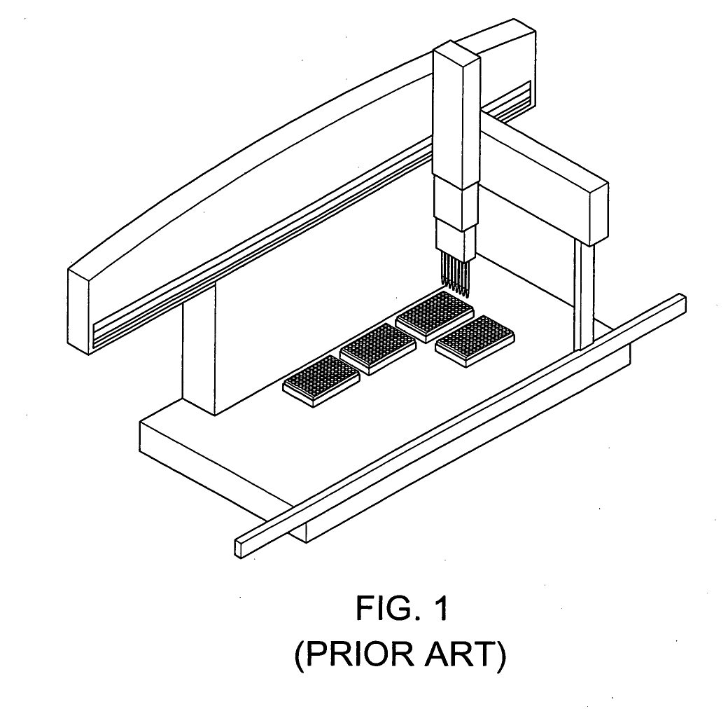

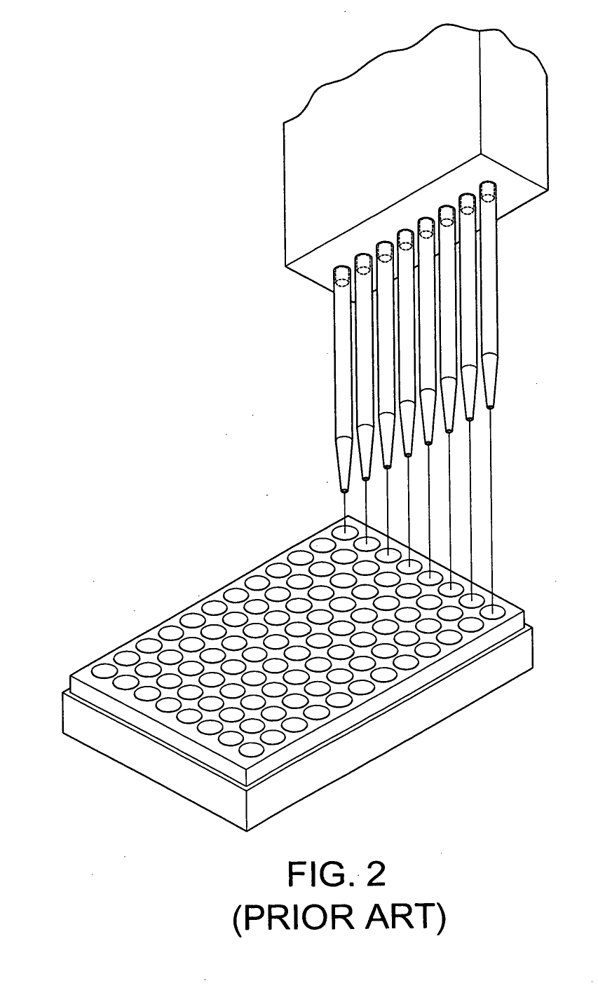

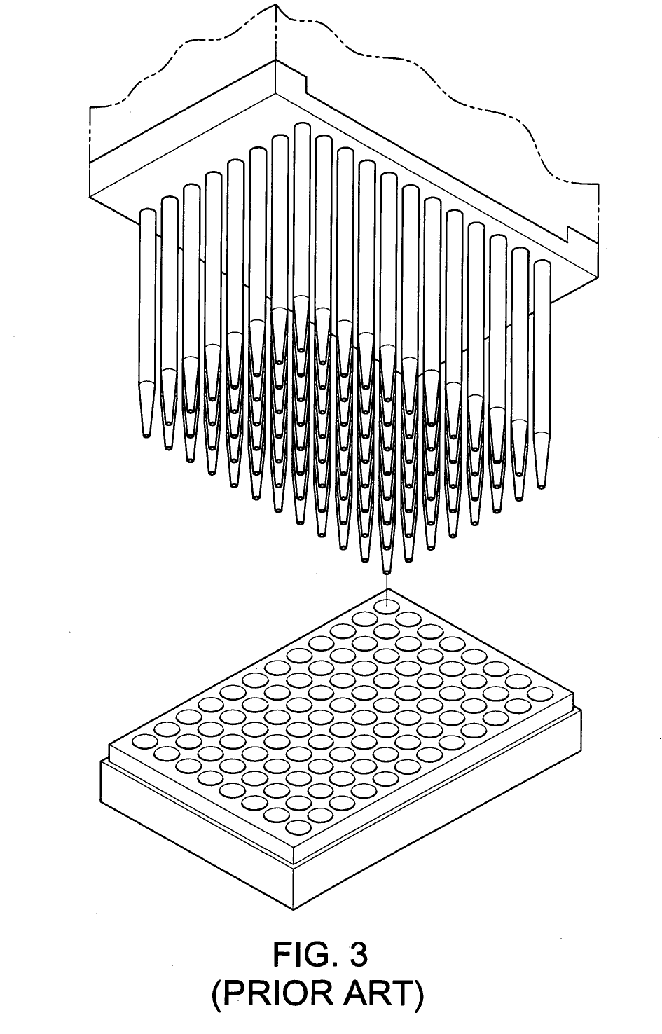

### DETAILED DESCRIPTION OF THE INVENTION

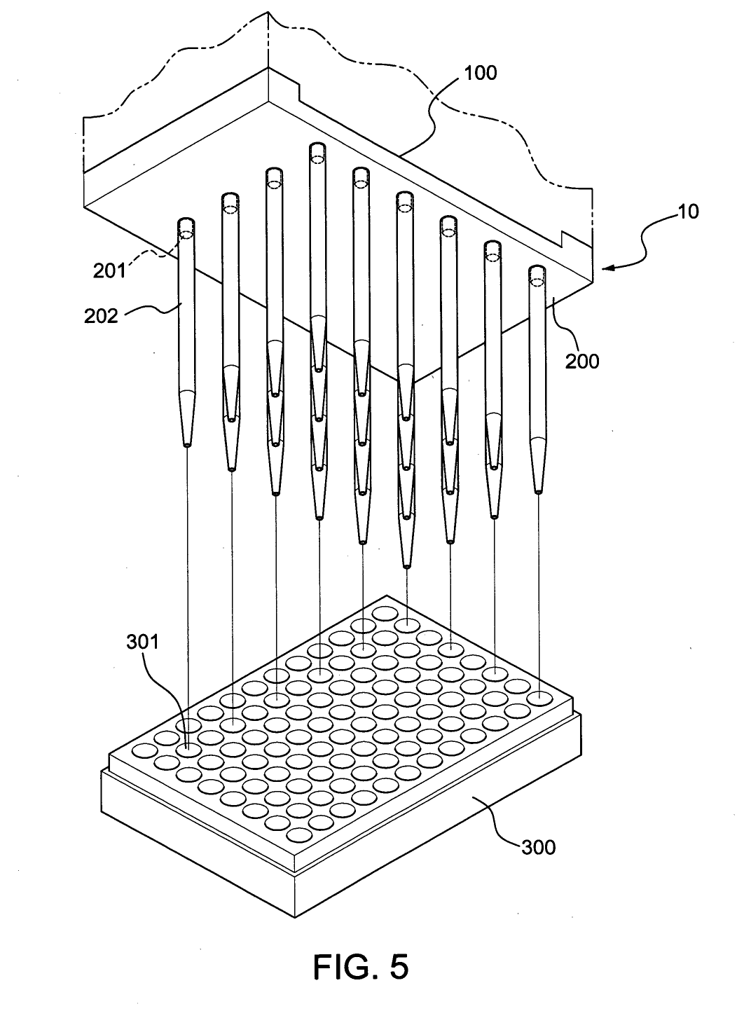

FIG. 5 illustrates a schematic view of a multi-channel liquid-handling pipette according to the present invention. The multi-channel liquid-handling pipette 10 has a top portion 100 and a bottom portion 200. The top portion 100 is disposed with a plurality of inlets (hidden from the figure) and the bottom portion 200 is disposed with a plurality of pipetting heads 201 for mounting tips 202. Each of the inlets (hidden from the figure) is connected to a syringe (hidden from the figure) or an apparatus with the functions of both quantitatively aspirating and dispensing liquid (not shown in the figure) and being in communication with the corresponding pipetting head 201. When the multi-channel liquid-handling pipette 10, which is mounted to and driven by an automated mechanical arm (not shown in the figure) or by hand (not shown in the figure), approaches a multi-well plate 300, each of the tips 202 corresponds to a respective well (or column) 301 of the multi-well plate 300 (referring to FIG. 7).

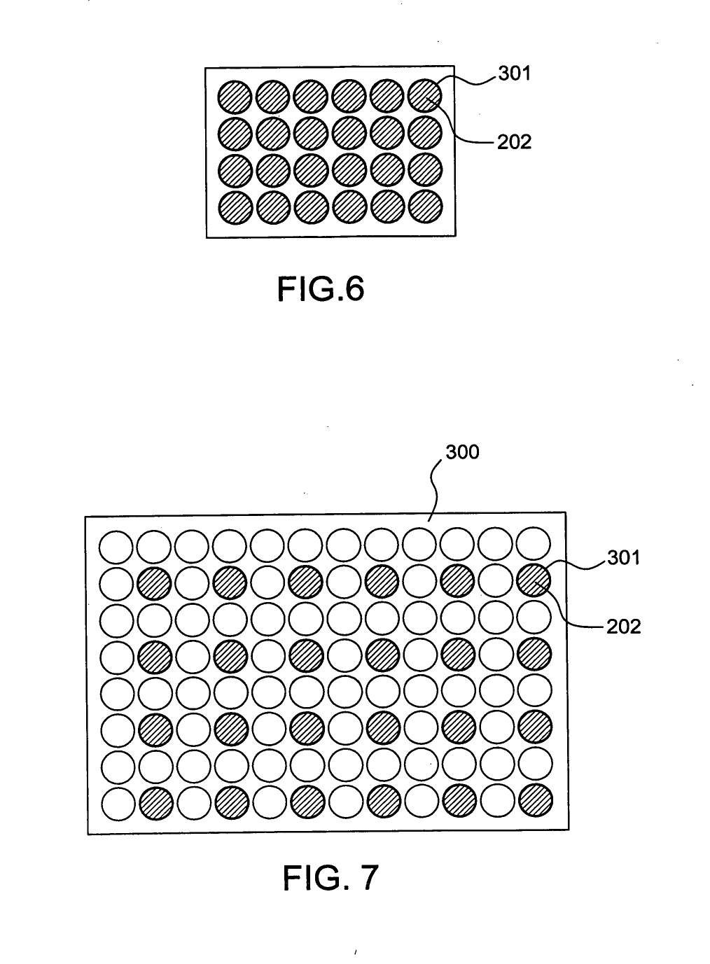

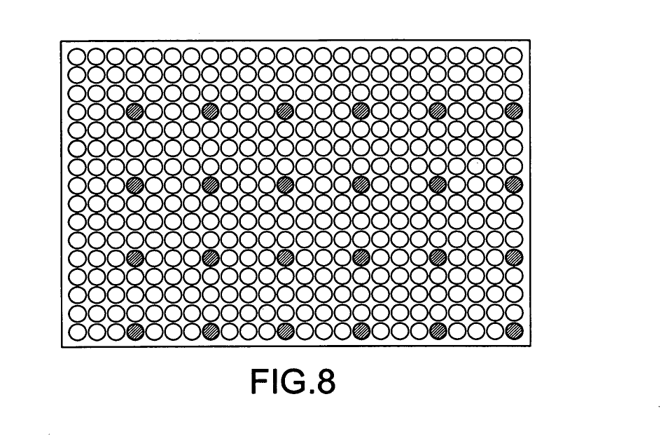

The multi-well plate 300 has a channel spacing between two adjacent wells 301, while the pipetting heads 201 can be arranged as a 6×4 array (referring to FIG. 5) having a channel spacing of 18 mm between two adjacent pipetting heads 201. The pipetting heads 201 can be further arranged in a manner such that the channel spacing of the pipetting heads divided by the channel spacing of the multi-well plate 300 is a power of two, e.g., 2 or 4, etc. As described in the Summary of the Invention, a conventional 6×4 (24) array multi-well plate has a channel spacing of 18 mm (referring to FIG. 6), a conventional 12×8 (96) array multi-well plate has a channel spacing of 9 mm (referring to FIG. 7), while a conventional 24×16 (384) array multi-well plate has a channel spacing of 4.5 mm (referring to FIG. 8), respectively. Thus, a typical multi-channel liquid-handling pipette 10 having a 6×4 array, which can be used for a 6×4 (24), 12×8 (96), or 24×16 (384) array multi-well plate, can have a channel spacing of 18 mm (referring to FIG. 6), 9 mm (referring to FIG. 7) or 4.5 mm (referring to FIG. 8) for different purposes. Since the ratio of the channel spacing of the pipetting heads 201 to the first channel spacing can always remain constant (a power of two), the multi-channel liquid-handling pipette 10 according to the present invention is flexible and can be easily modified and adapted for multi-well plates of different configurations, even when the channel spacing of conventional multi-well plates is modified for new generations of liquid handlers.

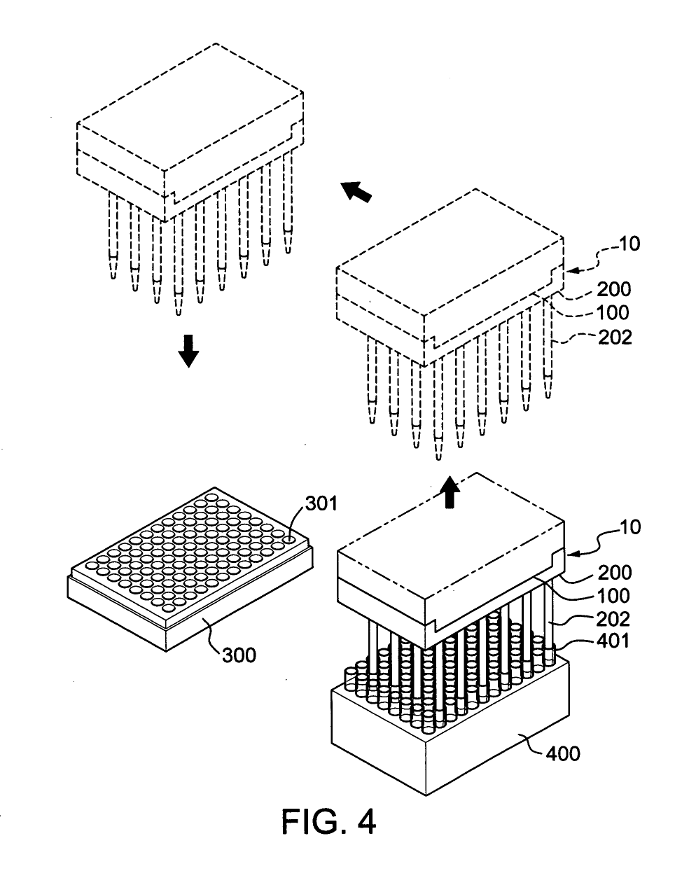

FIG. 4 illustrates a schematic view of a 6×4 multi-channel liquid-handling pipette performing “tube-to-plate transfers.” As stated in the previous paragraph, the multi-channel liquid-handling pipette (not shown in the figure) is mounted to and driven by an automated mechanical arm (not shown in the figure), which is often controlled by computer programmes. Thus, the multi-channel liquid-handling pipette can be easily controlled and driven to move either horizontally or vertically with respect to the multi-well plate 300 and a test tube rack 400. It can be seen that the multi-channel liquid-handling pipette can be easily controlled and driven to approach the corresponding test tubes 401 properly arranged as a 6×4 array in the test tube rack 400 having a centre-to-centre spacing of 18 mm to aspirate the liquids therein and can subsequently be moved to approach and dispense liquids to the corresponding wells 301 of the multi-well plate (referring to FIG. 7). In addition, because of its 18 mm channel spacing, the multi-channel liquid-handling pipette can easily handle a plurality of test tubes having a diameter from 9-18 mm when they are properly arranged. Further, since the number (12) of columns of the multi-well plate 300 divided by the number (6) of columns of the multi-channel liquid-handling pipette is 2, a power of 2, and the number (8) of rows of the multi-well plate 300 divided by the number (4) of rows of the multi-channel liquid-handling pipette is also 2, a power of 2, a complete cycle of “tube-to-plate transfers” can be accomplished by 2×2 (4) “aspirate and dispense” processes. Similar principles can therefore be applied to a multi-well plate having a 6×4 array or a 24×16 array. Other alternative forms of arrangements can also be easily modified without departing from the spirit and scope of the present invention.

From the above descriptions, it is apparent that the present invention provides a multi-channel adaptor for a liquid-handling apparatus which is flexible and can be easily modified and adapted for multi-well plates of different configurations and test tubes having a larger diameter, can speed up processing of liquid assays compared to the conventional 8-channel and 12-channel pipettes, and can overcome the defects in the prior art. While the invention has been described in terms of several preferred embodiments, those skilled in the art will recognise that the invention can still be practiced with modifications, within the spirit and scope of the appended claims.

What is claimed is:

1. A multi-channel liquid-handling pipette having a top portion and a bottom portion, the top portion being disposed with a plurality of inlets and the bottom portion being disposed with a plurality of pipetting heads for mounting tips, each inlet connecting to a syringe or an apparatus with the functions of both quantitatively aspirating and dispensing liquid and being in communication with the corresponding pipetting head, each tip corresponding to a respective well of a multi-well plate or a respective tube of a tube rack, the multi-well plate or the tube rack having an 18 mm channel spacing between two adjacent wells or tubes and being arranged as a 6×4 array, characterised in that:
the pipetting heads are arranged as a 6×4 array having an 18 mm channel spacing between two adjacent pipetting heads.

2. A multi-channel liquid-handling pipette having a top portion and a bottom portion, the top portion being disposed with a plurality of inlets and the bottom portion being disposed with a plurality of pipetting heads for mounting tips, each inlet connecting to a syringe or an apparatus with the functions of both quantitatively aspirating and dispensing liquid and being in communication with the corresponding pipetting head, each tip corresponding to a respective well of a multi-well plate, the multi-well plate having a 9 mm channel spacing between two adjacent wells and being arranged as a 12×8 array, characterised in that:
the pipetting heads are arranged as a 6×4 array having an 18 mm channel spacing between two adjacent pipetting heads.

3. A multi-channel liquid-handling pipette having a top portion and a bottom portion, the top portion being disposed with a plurality of inlets and the bottom portion being disposed with a plurality of pipetting heads for mounting tips, each inlet connecting to a syringe or an apparatus with the functions of both quantitatively aspirating and dispensing liquid and being in communication with the corresponding pipetting head, each tip corresponding to a respective well of a multi-well plate, the multi-well plate having a 4.5 mm channel spacing between two adjacent wells and being arranged as a 24×16 array, characterised in that:
the pipetting heads are arranged as a 6×4 array having an 18 mm channel spacing between two adjacent pipetting heads.
